(19) United States
(12) Patent Application Publication
(10) Pub. No.: US 2008/0170952 A1
(43) Pub. Date: Jul. 17, 2008

(54) HERMETIC COMPRESSOR

(76) Inventor: Si Hwan Jung, Buk-gu (KR)

Correspondence Address: BLANK ROME LLP, 600 NEW HAMPSHIRE AVENUE, N.W., WASHINGTON, DC, 20037, US

(21) Appl. No.: 11/955,051

(22) Filed: Dec. 12, 2007

(30) Foreign Application Priority Data
Jan. 15, 2007 (KR) 10-2007-0004082

(51) Int. Cl. H02K 3/30; H02K 3/02; H01B 7/00; B05D 5/12

(52) U.S. Cl. 417/423.7; 310/208; 174/120 C; 427/116; 427/118; 427/178

(57) ABSTRACT

A hermetic compressor includes a compressing device and a drive motor connected to the compressing device. The drive motor has a stator with a stator coil made of aluminum wire and an insulating layer disposed on an outer surface of the aluminum wire. The aluminum wire has a diameter between about 0.4 mm to about 1.2 mm.

### CROSS-REFERENCES TO RELATED APPLICATIONS

This application claims the benefit of Korean Patent Application No. 2007-0008508, filed on Jan. 26, 2007 in the Korean Intellectual Property Office, the disclosure of which is incorporated herein by reference.

This application may be related to U.S. Pat. No. 6,729,225, entitled “Connecting-Rod Apparatus of Hermetic Compressor,” granted May 4, 2004 to Seung-don Seo, the entire disclosure of which is incorporated herein by reference.

This application may be related to U.S. Pat. No. 6,893,233, entitled “Noise Reducing Cylinder Assembly for Compressor,” granted May 17, 2005 to Myung-Jung Hong, the entire disclosure of which is incorporated herein by reference.

This application may be related to U.S. Pat. No. 7,024,960, entitled “Connecting-Rod Apparatus of Hermetic Compressor,” granted Apr. 11, 2006 to Seung-don Seo, the entire disclosure of which is incorporated herein by reference.

This application may be related to co-pending U.S. patent application Ser. No. 11/109,724, entitled “Hermetic Compressor,” filed Apr. 20, 2005 by Yong Tae Yoon, the entire disclosure of which is incorporated herein by reference.

This application may be related to U.S. Pat. No. 7,225,724, entitled “Hermetic Compressor,” granted Dec. 21, 2006 to Sung Ro Lee, the entire disclosure of which is incorporated herein by reference.

This application may be related to U.S. Pat. No. 7,225,723, entitled “Hermetic Compressor,” granted Jun. 5, 2007 to Yong Tae Yoon, the entire disclosure of which is incorporated herein by reference.

This application may be related to co-pending U.S. patent application Ser. No. 11/474,987, entitled “Hermetic Type Compressor,” filed Jun. 27, 2006 by Jong Woon Park et al., the entire disclosure of which is incorporated herein by reference.

This application may be related to co-pending U.S. patent application Ser. No. 11/453,856, entitled “Hermetic Compressor,” filed Jun. 16, 2006 by Seung Don Seo, the entire disclosure of which is incorporated herein by reference.

This application may be related to co-pending U.S. patent application Ser. No. 11/486,255, entitled “Hermetic Compressor,” filed Jul. 14, 2006 by Yong Hyeon Cho, the entire disclosure of which is incorporated herein by reference.

This application may be related to co-pending U.S. patent application Ser. No. 11/435,686, entitled “Hermetic Compressor,” filed May 18, 2006 by Kyu Shik Shin, the entire disclosure of which is incorporated herein by reference.

This application may be related to co-pending U.S. patent application Ser. No. 11/452,954, entitled “Compressor,” filed Jun. 15, 2006 by Byung Hyun Kim, the entire disclosure of which is incorporated herein by reference.

This application may be related to co-pending U.S. patent application Ser. No. 11/447,157, entitled “Cylinder Assembly for Compressor and Assembling Method Thereof,” filed Jun. 6, 2006 by Jae Nam An, the entire disclosure of which is incorporated herein by reference.

This application may be related to co-pending U.S. patent application Ser. No. 11/808,155, entitled “Hermetic Type Compressor,” filed Jun. 7, 2007 by Jung Hyeon Kim, the entire disclosure of which is incorporated herein by reference.

This application may be related to co-pending U.S. patent application Ser. No. 11/812,372, entitled “Hermetic Type Compressor,” filed Jun. 18, 2007 by Myung Jung Hong, the entire disclosure of which is incorporated herein by reference.

This application may be related to co-pending U.S. patent application Ser. No. 11/808,155, entitled “Hermetic Type Compressor,” filed Jun. 7, 2007 by Jung Hyeon Kim, the entire disclosure of which is incorporated herein by reference.

This application may be related to co-pending U.S. patent application Ser. No. 11/826,768, entitled “Hermetic Compressor,” filed Jul. 18, 2007 by Rio Ryu, the entire disclosure of which is incorporated herein by reference.

### FIELD OF THE INVENTION

The present invention relates to a hermetic compressor for a refrigerator. In particular, the present invention relates to a hermetic compressor which reduces the manufacturing costs of a drive motor of the hermetic compressor while preventing loss of efficiency.

### BACKGROUND OF THE INVENTION

A conventional hermetic compressor includes a hermetic container defining the outer appearance thereof. The hermetic container has a compressing chamber formed therein. A compressing device to compress a refrigerant, and a drive motor to operate the compressing device are arranged in the hermetic container.

The drive motor provides operating power to the compressing device. The drive motor includes a stator mounted fixedly in the hermetic container, and a rotor rotatably mounted in the stator. The rotor is adapted to be rotated via electromagnetic interaction with the stator. The compressing device compresses the refrigerant using the rotation of the rotor.

The stator of the drive motor includes a core, and a plurality of stator coils wound on the core. The stator coils are connected to power lines extending from a terminal block. The terminal block is coupled to a terminal attached to the hermetic container. The terminal is adapted to receive power. Each stator coil is conventionally made of a copper wire, and an outer peripheral surface of the stator coil is coated with an insulating layer to prevent a short circuit with another stator coil.

While the drive motor is operating, a variety of motor losses occur, such as iron losses, copper losses of the stator, eddy current losses, windage losses of the rotor, etc. Accordingly, to enhance drive motor efficiency in view of the variety of motor losses, the core of the stator is often made of a low iron-loss material, and the stator coil is made of a copper wire having a purity of 99.90% or more. However, high-purity copper wire is expensive and difficult to obtain because of fluctuations in the international market price of copper. Thus, using copper wire results in a significant increase in the manufacturing costs of the drive motor.

### SUMMARY OF THE INVENTION

Therefore, it is an aspect of the invention to provide a hermetic compressor which reduces the manufacturing costs of the drive motor while preventing loss of efficiency.

One embodiment of the present invention provides a hermetic compressor. The hermetic compressor includes a compressing device; and a drive motor coupled to the compressing device, the drive motor having a stator with a stator coil made of aluminum wire and an insulating layer disposed on an outer surface of the aluminum wire, the aluminum wire having a diameter between about 0.4 mm to about 1.2 mm.

Another embodiment of the present invention provides a stator coil for a hermetic compressor. The stator coil includes an aluminum wire having diameter between about 0.4 mm and about 1.2 mm; the aluminum wire formed from aluminum with purity greater than 99.7%; an insulating layer disposed on an outer surface of the aluminum wire; and a self-layer disposed on the insulating layer.

Yet another embodiment of the present invention provides a method of manufacturing a stator coil for a hermetic compressor. The method of manufacturing includes the steps of: providing an aluminum wire having a diameter between about 0.4 mm to about 1.2 mm; coating the aluminum wire with an insulating layer; and winding the aluminum wire with the insulating layer onto the stator.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view of a hermetic compressor according to an exemplary embodiment of the present invention;

FIG. 2 is a perspective view of a stator of the hermetic compressor illustrated in FIG. 1; and

FIG. 3 is a sectional view of a stator coil of the stator illustrated in FIG. 2.

### DETAILED DESCRIPTION OF THE INVENTION

Reference will now be made in detail to a hermetic compressor 100 consistent with an exemplary embodiment of the present invention, examples of which are illustrated in the accompanying drawings, wherein like reference numerals refer to like elements throughout. The embodiment is described below to explain the present invention by referring to the figures.

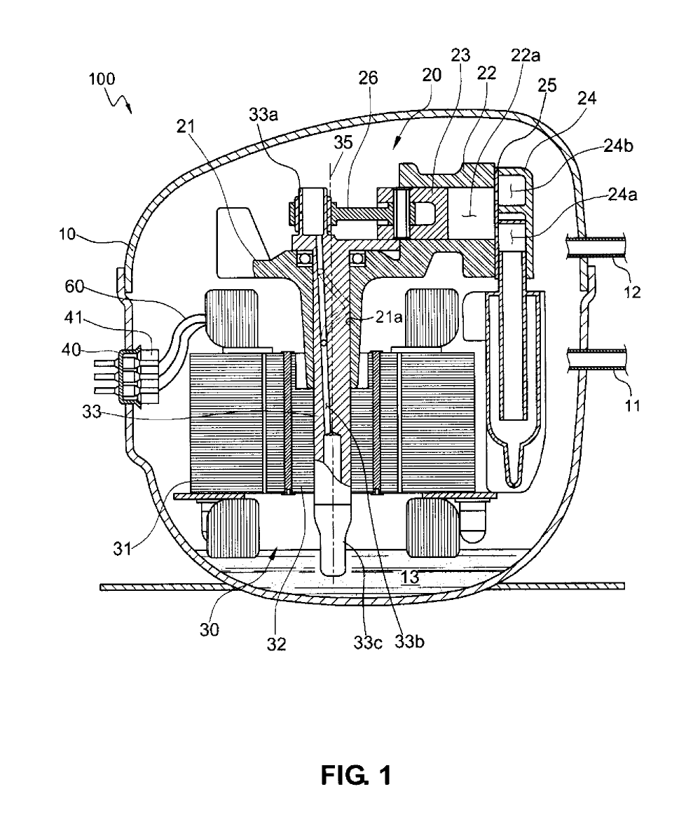

Referring to FIG. 1, the hermetic compressor 100 according to an embodiment of the present invention may include a hermetic container 10, a compressing device 20, and a drive motor 30. The hermetic container 10 forms a hermetic space therein. The compressing device 20 and the drive motor 30 may be arranged within the hermetic space. The compressing device 20 compresses a refrigerant. The drive motor 30 drives and operates the compressing device 20. A suction pipe 11 and a discharge pipe 12 may be disposed at a side of the hermetic container 10. The suction pipe 11 guides refrigerant into the hermetic container 10 from an evaporator (not shown) of a refrigeration cycle. The discharge pipe 12 guides the refrigerant away from the hermetic container 10 to a condenser (not shown) of the refrigeration cycle.

The compressing device 20 may include a frame 21, a cylinder 22, a compressing chamber 22a, a piston 23, a cylinder head 24, and a valve device 25. The cylinder 22 may be integrally formed with the frame 21. The cylinder 22 may be adapted to receive the piston 23 at one end and may be adapted to couple to the cylinder head 24 at an opposite end. A compressing chamber 22a may be defined within the cylinder 22 between the piston 23 and the cylinder head 24. The piston 23 may be adapted to linearly reciprocate within the cylinder 22. The cylinder head 24 may provide a hermetic seal for the opposite end of the cylinder 22. A refrigerant suction chamber 24a and a refrigerant discharge chamber 24b may be defined within the cylinder head 24. The suction chamber 24a may be adapted to guide refrigerant from the suction pipe 11 into the compressing chamber 22a. Similarly, the refrigerant discharge chamber 24b may be adapted to guide the refrigerant discharged from the compressing chamber 22a into the discharge pipe 12. The valve device 25 may be interposed between the cylinder 22 and the cylinder head 24. The valve device 25 controls the flow of the refrigerant being suctioned into the compressing chamber 22a from the refrigerant suction chamber 24a. The valve 25 also control the flow of refrigerant being discharged from the compressing chamber 22a into the refrigerant discharge chamber 24b.

The drive motor 30 can cause the piston 23 to linearly reciprocate so that it compresses the refrigerant in the compressing device 20. The drive motor 30 may include a stator 31 and a rotor 32. The stator 31 may be mounted fixedly to the frame 21 opposite the compressing device 20. The stator 31 may be adapted to create a magnetic field. The rotor 32 may be rotatably mounted within the stator 31 spaced apart from the stator 30. The rotor 32 may be adapted to rotate via electromagnetic interaction with the stator 31.

The drive motor 30 may be coupled to a rotating shaft 33, and the rotating shaft 33 may be coupled to the compressing device 20. The rotating shaft 33 may be inserted into a central hollow portion 21a formed in the frame 21. The rotating shaft 33 may be rotatably supported within the hollow portion 21a. A portion of the rotating shaft 33 may be press-fitted into the center of the rotor 32 and thus rotate with the rotor 32. An opposite portion of the rotating shaft 33 may protrude from the frame 21 and form an eccentric shaft portion 33a. The eccentric shaft portion 33a is not formed concentrically with the rotating shaft 33, and thus, when the rotor 32 rotates, the eccentric shaft portion 33a revolves around the longitudinal axis 35 of the rotating shaft 33. The eccentric shaft portion 33a may be coupled to a connecting rod 26, and the connecting rod 26 may be coupled to the piston 23. The connecting rod 26 may convert the eccentric rotating motion of the eccentric shaft portion 33a into the linearly reciprocating motion of the piston 23.

Accordingly, when electric current is applied to the hermetic compressor 100, the stator 31 creates a magnetic field. Then, the rotor 32 rotates due to an electromagnetic interaction with the stator 31. Thus, the eccentric shaft portion 33a of the rotating shaft 33 revolves around the longitudinal axis 35 of the rotating shaft 33, thereby causing the piston 22 to linearly reciprocate within the cylinder 22 because the piston 22 is connected to the eccentric shaft portion 33a via the connecting rod 26. The linear reciprocation of the piston 22 causes a difference in pressure to develop between an interior and an exterior of the compressing chamber 22a. As the piston 22 moves away from the cylinder head 24 and expands the compressing chamber 22a, refrigerant guided to the refrigerant suction chamber 24a by the suction pipe 11 is suctioned into the compressing chamber 22a. As the piston 22 moves towards the cylinder head 24 and presses the compressing chamber 22a, the piston 22 compresses the refrigerant in the compressing chamber 22a. Next, the compressed refrigerant discharges from the compressing chamber 22a into the refrigerant discharge chamber 24a. Then, the discharge pipe 12 may guide the refrigerant from the refrigerant discharge chamber 24a to the condenser of the refrigeration cycle.

To prevent wear due to excessive friction between moving parts, such as between the rotating shaft 33 and the frame 21 or between the connecting rod 26 and the eccentric shaft portion 33a, oil can be provided to lubricate and cool moving parts of the compressing device 20 and the drive motor 30. An oil storage space 13 for storing a predetermined amount of oil may be defined in a lower portion of the hermetic container 10. Also, the rotating shaft 33 may have an oil path 33b to guide oil from the oil storage space 13 to the moving parts. Centrifugal force generated by the rotation of the rotating shaft 33 may cause the oil to flow. An oil pickup member 33c may be provided at a lower end of the rotating shaft 33. The oil pickup member 33c may be adapted to gather oil from the oil storage space 13. The oil pickup member 33c can provide a pathway between the oil path 33b and the oil storage space 13. Thus, while compressing refrigerant, the oil pickup member 33c gathers oil from the oil storage space 13 and provides a pathway for the oil to the oil path 33. The oil flows through the oil path 33b to the moving parts because of the centrifugal force of the rotating shaft 33. Then, the oil provides lubrication and cooling to the moving parts of the compressing device 20 and the drive motor 30.

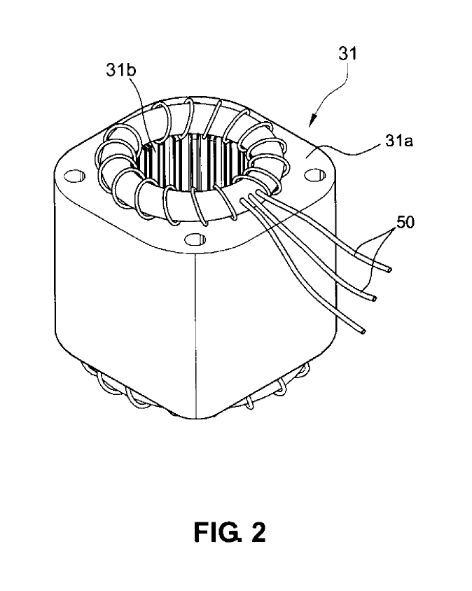

To supply electrical power to the stator, the hermetic container 10 includes a terminal 40. At one end, the terminal 40 may be coupled to an external power source, and at another end, the terminal 40 may be coupled to a terminal block 41 inside the hermetic container 10. A plurality of power lines 60 may extend from the terminal block 41 to the stator 31. Referring to FIG. 2, the stator 31 has a plurality of stator coils 50 wound on a core 31a. To apply electric current to the stator 31, one end of the respective stator coils 50 is connected to a corresponding respective power line 60 extending from the terminal block 41.

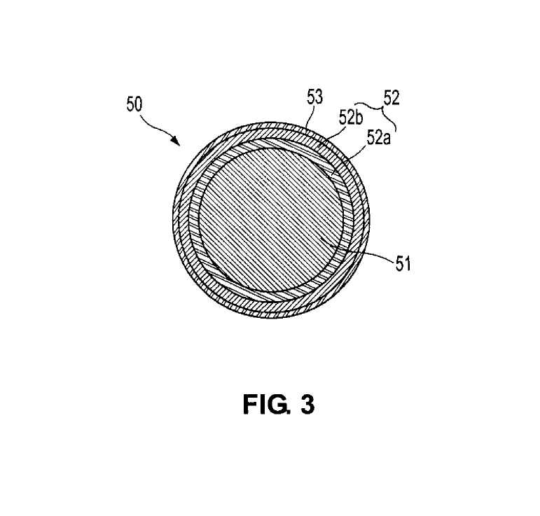

Referring to FIG. 3, each stator coil 50 is composed of an aluminum wire 51. Aluminum wire is preferably used because it is less costly than copper wire and the international market price of aluminum is relatively more stable than the international market price of copper. Thus, stator coils 50 made from aluminum wire 51 reduces the manufacturing costs of the drive motor 30.

Stator coils 50 made from aluminum wire 51 may have a lower conductivity than a conventional stator coil made from copper wire, however. To compensate for the lower conductivity, the aluminum wire 51 preferably has a larger diameter than the copper wire of a conventional stator coil. Preferably, the diameter is in the range of about 0.4 mm to about 1.2 mm. Also, the aluminum wire 51 is preferably made from a preform of Aluminum 1350 wire or Aluminum 1370 wire having purity greater than 99.7% by continuous casting and rolling (CCR). A large-diameter aluminum wire 51 made from high purity aluminum has conductivity similar to copper wire. Thus, the drive motor 30 of the present invention can achieve similar operating efficiency as the conventional drive motor.

On an outer layer of the aluminum wire 51, an insulating layer 52 is disposed to prevent a short circuit with another stator coil 50. The insulating layer 52 may be formed of a synthetic resin. To increase the amount of insulation while maintaining tensile and bending strengths of the stator coil 50, the insulating layer 52 may be made of an inner insulating layer 52a and an outer insulating layer 52b (FIG. 3). Copper wire has a tensile strength of 22 kg/mm², but aluminum wire has a tensile strength of 10 kg/mm². Therefore, there is a risk that when tensile force is applied to the stator coil 50 composed of aluminum wire 51, the stator coil 50 will break due to its relatively lower tensile strength. Accordingly, providing the aluminum wire 51 with two insulating layers 52a and 52b prevents a reduction in the tensile and bending strengths of the stator coil 50 composed of aluminum wire 51. In one embodiment, the inner insulating layer 52a is made of polyester-imide, and the outer insulating layer 52b is made of poly-amide-imide.

The stator coil 50 is wound on an insulating sheet 31b by use of a winding machine (not shown). Prior to winding the stator coil 50, the insulating sheet 31b is fitted inside the core 31a. However, the stator coil 50 may be scratched by the core 31a or the insulating sheet 31b as it is being wound thereon. Thus, the insulating layer 52 of the stator coil 50 may be damaged, and consequently a short circuit may develop between stator coils 50. To prevent damage to the insulating layer 52, the stator coil 50 may include a synthetic resin self-lubricating layer 53 (FIG. 3) disposed on an outer surface of the outer insulating layer 52b. The self-lubricating layer 53 may be obtained by adding a lubricant into the poly-amide-imide composing the outer insulating layer 52b. Thus, when the self-lubricating layer 53 is provided, if the stator coil 50 is scratched by the core 31a or the insulating sheet 31b, the self-lubricating layer 53 can provide lubrication to prevent wear of the stator coil 50 and prevent damage to the insulating layer 52. The self-lubricating layer 53 can also increase the rigidity of the stator coil 50 along with the insulating layer 52.

A benefit of using polyester-imide or poly-amide-imide is that neither undergoes an undesirable chemical reaction with the oil in the oil storage space 13 or the refrigerant in the hermetic container 10. Thus, the insulating layer 52 and the self-lubricating layer 53 made of polyester-imide or poly-amide-imide can protect the stator coil 50 from unwanted chemical interaction with the oil or the refrigerant.

As apparent from the above description, according to a hermetic compressor of the present invention, the stator coil, employed in the stator of the drive motor, is composed of a large-diameter aluminum wire. Using large-diameter aluminum wire reduces the manufacturing costs of the drive motor and substantially maintains the efficiency of the drive motor. Also, the dual insulating layer made of synthetic resin disposed on the outer surface of the aluminum wire provides the stator coil with tensile and bending strength. Furthermore, the self-lubricating layer made of synthetic resin substantially prevents damage to the insulating layer.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A hermetic compressor, comprising:
a compressing device; and
a drive motor coupled to the compressing device, the drive motor having a stator with a stator coil made of aluminum wire and an insulating layer disposed on an outer surface of the aluminum wire, the aluminum wire having a diameter between about 0.4 mm to about 1.2 mm.

2. The hermetic compressor according to claim 1, wherein the aluminum wire is made of aluminum having purity greater than 99.7%.

3. The hermetic compressor according to claim 2, wherein the insulating layer is made of synthetic resin.

4. The hermetic compressor according to claim 2, wherein the insulating layer comprises an inner insulating layer and an outer insulating layer around the inner insulating layer.

5. The hermetic compressor according to claim 3, wherein the inner insulating layer is made of polyester-imide, and the outer insulating layer is made of poly-amide-imide.

6. The hermetic compressor according to claim 1, further comprising a self-lubricating layer disposed on an outer surface of the aluminum wire.

7. The hermetic compressor according to claim 6, wherein the self-lubricating layer is made of polyamide-imide and a lubricant.

8. A stator coil for a hermetic compressor, comprising:
an aluminum wire having diameter between about 0.4 mm and about 1.2 mm; the aluminum wire formed from aluminum with purity greater than 99.7%;
an insulating layer disposed on an outer surface of the aluminum wire; and
a self-lubricating layer disposed on the insulating layer.

9. The stator coil according to claim 8, wherein the insulating layer comprises an inner insulating layer and an outer insulating layer around the inner insulating layer.

10. The stator coil according to claim 9, wherein the inner insulating layer is made of polyester-imide, and the outer insulating layer is made of poly-amide-imide.

11. The stator coil according to claim 8, wherein the insulating layer is made of synthetic resin.

12. The stator coil according to claim 8, wherein the self-lubricating layer is made of polyamide-imide and a lubricant.

13. A method of manufacturing a stator coil for a hermetic compressor, comprising the steps of:
providing an aluminum wire having a diameter between about 0.4 mm to about 1.2 mm;
coating the aluminum wire with an insulating layer; and
winding the aluminum wire with the insulating layer onto the stator.

14. The method of manufacturing according to claim 13, further comprising the steps of:
providing aluminum with purity greater than 99.7%; and
forming aluminum wire from the aluminum.

15. The method of manufacturing according to claim 13, wherein the insulating layer is made of synthetic resin.

16. The method of manufacturing according to claim 13, further comprising the steps of:
coating the aluminum wire with an inner insulating layer; and
coating the inner insulating layer with an outer insulating layer.

17. The method of manufacturing according to claim 15, wherein the inner insulating layer is made of polyester-imide, and the outer insulating layer is made of poly-amide-imide.

18. The method of manufacturing according to claim 13, further comprising the step of disposing a self-lubricating layer on an outer surface of the aluminum wire.

19. The method of manufacturing according to claim 17, wherein the self-lubricating layer is made of polyamide-imide and a lubricant.
